(19) United States
(12) Patent Application Publication
(10) Pub. No.: US 2019/0384298 A1
(43) Pub. Date: Dec. 19, 2019

(54) CONTROL METHOD AND UAV

(71) Applicant: SZ DJI TECHNOLOGY CO., LTD., Shenzhen (CN)

(72) Inventor: Lijian LIU, Shenzhen (CN)

(21) Appl. No.: 16/528,180

(22) Filed: Jul. 31, 2019

Related U.S. Application Data
(63) Continuation of application No. PCT/CN2017/077533, filed on Mar. 21, 2017.

(51) Int. Cl. G05D 1/00; B64C 39/02; G05D 1/06; B64C 19/00

(52) U.S. Cl. CPC G05D 1/0094; B64C 39/028; G05D 1/0033; B64C 2201/146; B64C 39/024; B64C 19/00; B64C 2201/08; G05D 1/0669

(57) ABSTRACT

A control method includes determining whether an unmanned aerial vehicle (UAV) is being thrown off, determining whether the UAV is detached from a user in response to the UAV being thrown off, determining whether the UAV has a safe distance from the user in response to the UAV being detached from the user, and controlling the UAV to fly in response to the UAV having the safe distance from the user.

### CROSS-REFERENCE TO RELATED APPLICATION

This application is a continuation application of International Application No. PCT/CN2017/077533, filed on Mar. 21, 2017, the entire content of which is incorporated herein by reference.

### TECHNICAL FIELD

The present disclosure relates to unmanned aerial vehicle (UAV) technology and, more particularly, to a control method and a UAV.

### BACKGROUND

In order to realize a hand launching of an unmanned aerial vehicle (UAV), acceleration information of the UAV is generally obtained by an acceleration sensor of the UAV to determine whether the UAV has been thrown off. When it is determined that the UAV has been thrown off, a motor of the UAV is started. However, since a UAV throwing manner performed by a user cannot be strictly restricted, a false positive rate based on the acceleration information of the UAV to determine whether the UAV has been thrown off by the user is high, thereby resulting a high security risk.

### SUMMARY

In accordance with the disclosure, there is provided a control method including determining whether an unmanned aerial vehicle (UAV) is being thrown off, determining whether the UAV is detached from a user in response to the UAV being thrown off, determining whether the UAV has a safe distance from the user in response to the UAV being detached from the user, and controlling the UAV to fly in response to the UAV having the safe distance from the user.

Also in accordance with the disclosure, there is provided an unmanned aerial vehicle (UAV) including a processor and a flight control system coupled to the processor. The processor is configured to determine whether the UAV is being thrown off, determine whether the UAV is detached from a user in response to the UAV being thrown off, and determine whether the UAV has a safe distance from the user in response to the UAV being detached from the user. The flight control system is configured to control the UAV to fly in response to the UAV having the safe distance from the user.

### BRIEF DESCRIPTION OF THE DRAWINGS

In order to illustrate the technical solutions of the present disclosure, the drawings used in the description of embodiments will be briefly described.

FIG. 1 schematically shows a hand launching of an unmanned aerial vehicle (UAV) consistent with the disclosure.

FIG. 2 is a schematic flow chart of a control method consistent with the disclosure.

FIG. 3 is a schematic diagram of functional circuits of a UAV consistent with the disclosure.

FIG. 4 is a schematic flow chart of another control method consistent with the disclosure.

FIG. 5 is a schematic flow chart of another control method consistent with the disclosure.

FIG. 6 is a schematic diagram of functional circuits of another UAV consistent with the disclosure.

FIG. 7A is a schematic diagram of an acceleration curve model of a UAV consistent with the disclosure.

FIG. 7B is a schematic diagram of an example throwing action consistent with the disclosure.

FIG. 8 shows a comparison between a schematic acceleration curve of an actual flight of a UAV consistent with the disclosure and the acceleration curve model.

FIG. 9 is a schematic flow chart of another control method consistent with the disclosure.

FIG. 10 is a schematic diagram of functional circuits of another UAV consistent with the disclosure.

FIG. 11 is a schematic flow chart of another control method consistent with the disclosure.

FIG. 12 is a schematic diagram of functional circuits of another UAV consistent with the disclosure.

FIG. 13 is a schematic flow chart of another control method consistent with the disclosure.

FIG. 14 is a schematic diagram of functional circuits of another UAV consistent with the disclosure.

FIG. 15 is a schematic flow chart of another control method consistent with the disclosure.

FIG. 16 is a schematic diagram of functional circuits of another UAV consistent with the disclosure.

FIG. 17 is a schematic flow chart of another control method consistent with the disclosure.

FIG. 18 is a schematic diagram of functional circuits of another UAV consistent with the disclosure.

FIG. 19 schematically shows calculating a horizontal distance consistent with the disclosure.

FIG. 20 is a schematic flow chart of another control method consistent with the disclosure.

FIG. 21 is a schematic diagram of functional circuits of another UAV consistent with the disclosure.

FIG. 22 is a schematic flow chart of another control method consistent with the disclosure.

FIG. 23 is a schematic diagram of functional circuits of another UAV consistent with the disclosure.

FIG. 24 schematically shows calculating a vertical distance consistent with the disclosure.

FIG. 25 is a schematic flow chart of another control method consistent with the disclosure.

### DETAILED DESCRIPTION OF THE EMBODIMENTS

Example embodiments will be described with reference to the accompanying drawings, in which the same numbers refer to the same or similar elements unless otherwise specified. It will be appreciated that the described embodiments are merely example and illustrative, and not intended to limit the scope of the disclosure.

The terms “first,” “second,” or the like in the specification, claims, and the drawings of the disclosure are merely illustrative, e.g. distinguishing similar elements, defining technical features, or the like, and are not intended to indicate or imply the importance of the corresponding elements or the number of the technical features. Thus, features defined as “first” and “second” may explicitly or implicitly include one or more of the features. As used herein, “a plurality of” means two or more, unless there are other clear and specific limitations.

As used herein, the terms “mounted,” “coupled,” and “connected” should be interpreted broadly, unless there are other clear and specific limitations. For example, the connection between two assemblies may be a fixed connection, a detachable connection, or an integral connection. The connection may also be a mechanical connection, an electrical connection, or a mutual communication connection. Furthermore, the connection may be a direct connection or an indirect connection via an intermedium, an internal connection between the two assemblies or an interaction between the two assemblies. The specific meanings of the above terms in the present disclosure can be understood by those skilled in the art on a case-by-case basis.

Various example embodiments corresponding to different structures of the disclosure will be described. For simplification purposes, the elements and configurations for the example embodiments are described below. It will be appreciated that the described embodiments are example only and not intended to limit the scope of the disclosure. Moreover, the references of numbers or letters in various example embodiments are merely for the purposes of clear and simplification, and do not indicate the relationship between the various example embodiments and/or configurations. In addition, the use of other processes and/or materials will be apparent to those skilled in the art from consideration of the examples of various specific processes and materials disclosed herein.

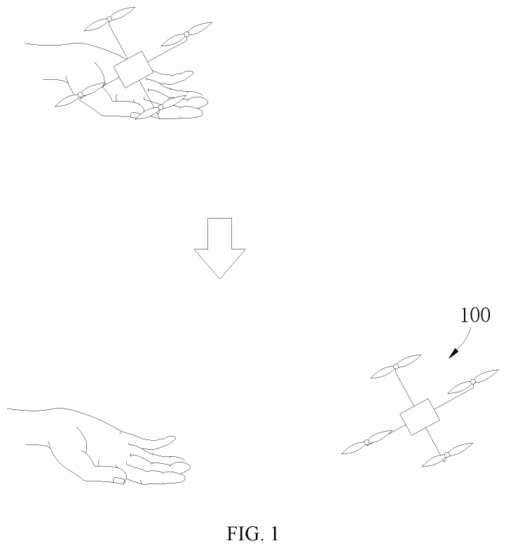

FIG. 1 schematically shows example hand launching of an unmanned aerial vehicle (UAV) 100 consistent with the disclosure. Hand launching refers to that a user throws the UAV 100 off a hand of the user, and the UAV 100 can automatically fly after being thrown off. The hand launching of the UAV 100 can simplify a take-off operation of the UAV 100.

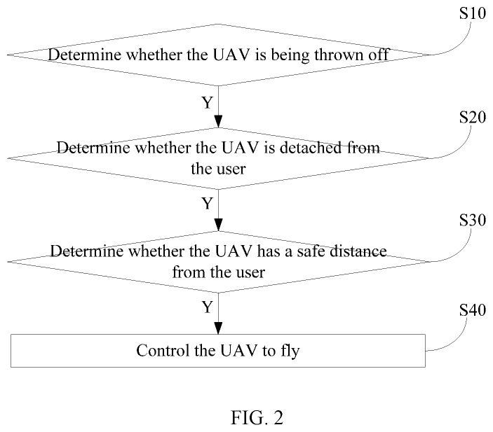

FIG. 2 is a schematic flow chart of an example control method consistent with the disclosure. The control method in FIG. 2 can be used to control the hand launching of the UAV 100. As shown in FIG. 2, at S10, whether the UAV 100 is being thrown off is determined.

At S20, in response to the UAV 100 being thrown off, whether the UAV 100 is detached from the user is determined.

At S30, in response to the UAV 100 being detached from the user, whether the UAV 100 has a safe distance from the user is determined.

At S40, in response to the UAV 100 having the safe distance from the user, the UAV 100 is controlled to fly.

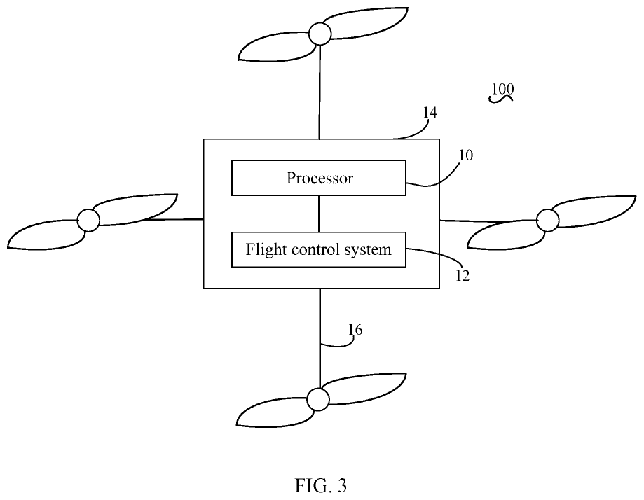

FIG. 3 is a schematic diagram of functional circuits of an example of the UAV 100 consistent with the disclosure. As shown in FIG. 3, the UAV 100 includes a processor 10 and a flight control system 12 coupled to the processor 10. The processor 10 can be configured to determine whether the UAV 100 is being thrown off. The processor 10 can be further configured to, in response to the UAV 100 being thrown off, determine whether the UAV 100 is detached from the user. The processor 10 can be further configured to, in response to the UAV 100 being detached from the user, determine whether the UAV 100 has the safe distance from the user. The flight control system 12 can be configured to, in response to the UAV 100 having the safe distance from the user, control the UAV 100 to fly. That is, the processor 10 can be configured to perform the processes at S10, S20, and S30, and the flight control system 12 can be configured to perform the process at S40.

In some embodiments, the UAV 100 further includes a body 14 and a plurality of arms 16. The plurality of arms 16 can be arranged at the body 14, and radially distributed at the body 14. The processor 10 and the flight control system 12 may be arranged at the body 14 and/or the plurality of arms 16.

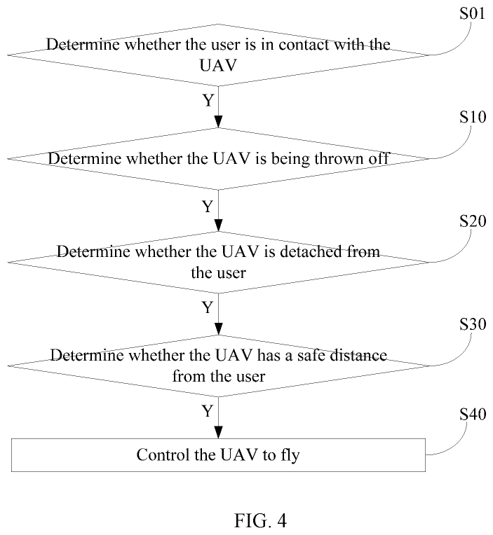

FIG. 4 is a schematic flow chart of another example control method consistent with the disclosure. In some embodiments, as shown in FIG. 4, before the process at S10, at S01, whether the user is in contact with the UAV 100 is determined. When the user is in contact with the UAV 100, the process at S10 can be implemented.

Referring again to FIG. 3, in some embodiments, the processor 10 can be further configured to determine whether the user is in contact with the UAV 100, and when the user is in contact with the UAV 100, determine whether the UAV 100 is being thrown off. That is, the processor 10 can be further configured to perform the process at S01.

By implementing the process at S01, the processor 10 can confirm that the UAV 100 is being contacted by the user, for example, being held in the hand(s) of the user, before the UAV 100 is thrown off. As such, a situation that the UAV 100 has already been detached from the user, for example, the UAV 100 is already in flight, before the implementation of the process at S10 can be precluded. Since some motion characteristics of the UAV 100 during flight may be the same as the motion characteristics when being thrown off, the processor 10 may misjudge that the UAV 100 is being thrown off the hand by the user when the UAV is actually in flight, thereby causing an influence on an original flight path of the UAV 100.

In some embodiments, at S01, whether the user is in contact with a predetermined position of the UAV 100, for example, a bottom of the body 14 of the UAV 100 or a position on a periphery of at least one of the plurality of arms 16 of the UAV 100, can be determined. The user may lift the bottom of the body 14 or grab at least one of the plurality of arms 16 to prepare for the hand launching. In some embodiments, at S30, whether a contact sequence of the user with the UAV 100 conforms to a preset contact sequence for a preparation of the hand launching can be determined. The preset contact sequence can include, for example, holding the UAV 100 and tapping the body 14 of the UAV 100 for a predetermined number of times, switching from grapping a side of the body 14 to holding the bottom of the body 14, or the like.

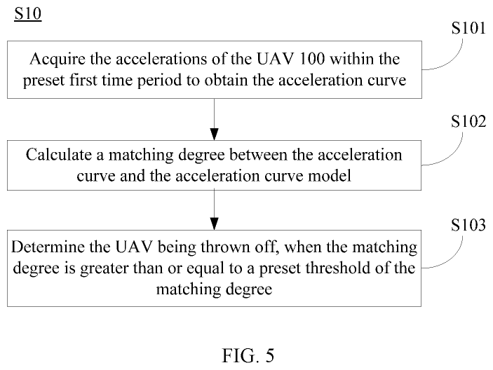

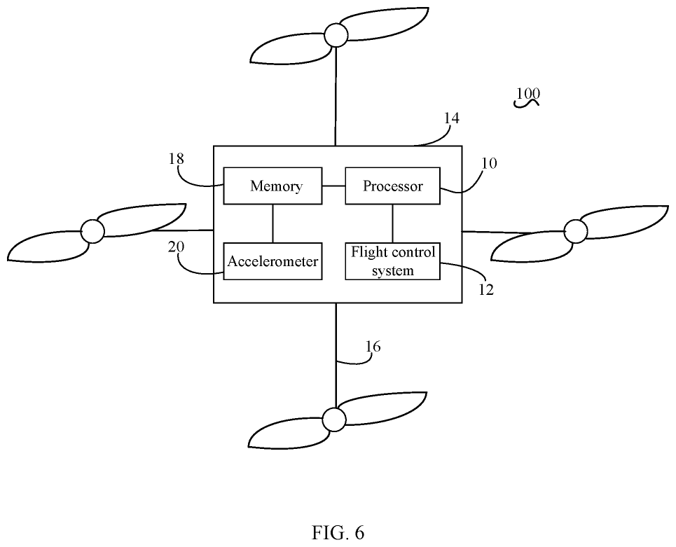

FIG. 5 is a schematic flow chart of another control method consistent with the disclosure. FIG. 6 is a schematic diagram of the functional circuits of another example of the UAV 100 consistent with the disclosure. As shown in FIG. 6, the UAV 100 further includes a memory 18 coupled to the processor 10 and an accelerometer 20 coupled to the memory 18. The accelerometer 20 can be configured to detect and record accelerations of the UAV 100 within a preset first time period to obtain an acceleration curve, also referred to as an “actual acceleration curve. The memory 18 can be configured to store an acceleration curve model corresponding to the UAV 100 being thrown off.

As shown in FIG. 5, the process at S10 can include the following processes. At S101, the accelerations of the UAV 100 within the preset first time period are acquired to obtain the acceleration curve.

At 102, a matching degree between the acceleration curve and the acceleration curve model is calculated.

At 103, when the matching degree is greater than or equal to a preset matching degree threshold, it is determined that the UAV 100 is being thrown off.

In some embodiments, the processor 10 can be configured to acquire the accelerations of the UAV 100 within the preset first time period to obtain the acceleration curve, calculate the matching degree between the acceleration curve and the acceleration curve model, and when the matching degree is greater than or equal to the preset matching degree threshold, determine that the UAV 100 is being thrown off. That is, the processor 10 can be configured to perform the processes at S101, S102, and S103.

In some embodiments, at S10, whether the UAV 100 is being thrown off by the user can be determined according to acceleration characteristics of the UAV 100. It can be appreciated that a certain throwing action can occur when the user holds the UAV 100 and prepare to throw the UAV 100. For example, when the user is preparing to throw the UAV 100 upward, the UAV 100 may be pulled down and then thrown up. The UAV 100 may even be repeatedly pulled down and pulled up for several times before being thrown up. As another example, when the user is preparing to throw the UAV 100 forward, the UAV 100 may be pulled back and thrown forward. The UAV 100 may even be repeatedly pulled back and pulled forward for several times before being thrown forward.

The memory 18 can be configured to store the acceleration curve model(s) corresponding to the situation when the UAV 100 is being thrown off. The number of the acceleration curve models can be more than one. Each acceleration curve model may have time as a horizontal axis of the acceleration curve, and the acceleration of the UAV 100 in a certain direction as a vertical axis of the acceleration curve.

In some embodiments, at S101, acquiring the accelerations of the UAV 100 within the preset first time period can include recording accelerations of the UAV 100 in a horizontal direction and accelerations of the UAV 100 in a vertical direction. The first time period may include a time duration from a current time point to a previous time point. The previous time point refers to a time point happens ahead of the current time point.

In some embodiments, at S102, calculating the matching degree between the acceleration curve and the acceleration curve model can include obtaining the matching degree according to a preset comparison rule. The matching degree can be represented by a number of 0 to 100%. A larger number can indicate a higher matching degree. The comparison rule can be preset when the UAV 100 is manufactured in a factory.

In some embodiments, the matching degree threshold at S103 can be preset when the UAV 100 is manufactured in the factory. In some embodiments, the preset matching degree threshold can be modified by the user. The preset matching degree threshold can be, for example, 50%, 65%, 80.2%, or the like.

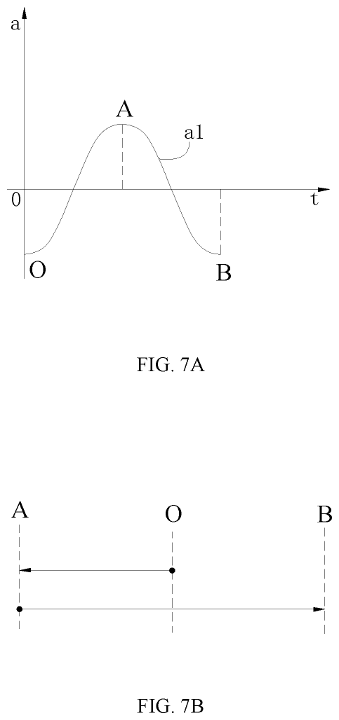

FIG. 7A is a schematic diagram of an example acceleration curve model of the UAV 100 consistent with the disclosure. As shown in FIG. 7A, the acceleration curve model is a curve model in which the time is the horizontal axis and the acceleration of the UAV 100 in the horizontal direction is the vertical axis. The corresponding throwing action of the user can include the user pulling the UAV 100 back first and then throwing forward. FIG. 7B is a schematic diagram of an example throwing action consistent with the disclosure. As shown in FIG. 7B, the user can pull the UAV 100 from point O back to point A, and then pull the UAV 100 from point A to point B, and then throw the UAV 100 at point B. A change of a magnitude and direction of the acceleration of the UAV 100 occurred during the throwing action can be similar to a curve model a1.

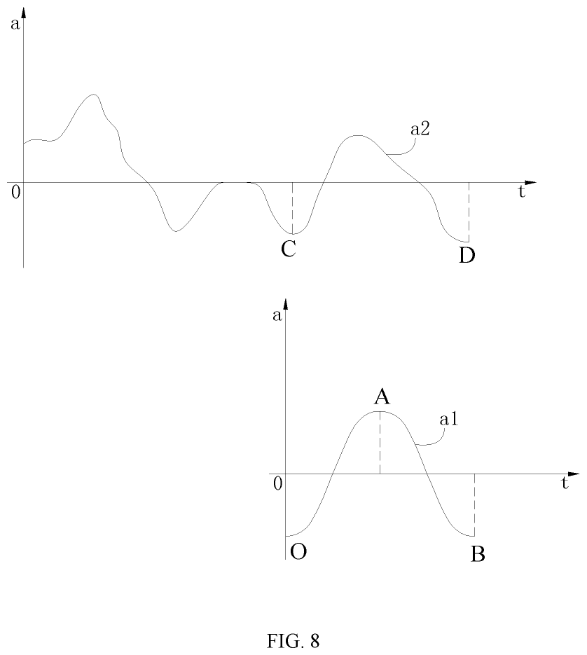

FIG. 8 shows the comparison between a schematic acceleration curve a2 of an actual flight of the UAV 100 consistent with the disclosure and the curve model a1. As shown in FIG. 8, the acceleration curve a2 is a horizontal acceleration curve a2 of the UAV 100 in the first time period. The curve a2 before point C has a lower matching degree with the curve model a1, for example, the curve a2 stays longer in a state where the acceleration is zero. The acceleration of the UAV 100 in the horizontal direction between point C and point D has a higher matching degree with the curve model a1, for example, a trend of a2 is similar to a trend of a1. Thus, it can be determined that the UAV 100 is being thrown off by the user during the time period between point C and point D.

FIG. 8 is merely illustrative of a feasible solution for determining whether the UAV 100 is being thrown off according to the matching degree between the obtained acceleration curve and the acceleration curve model. In practical applications, a design of the acceleration curve model, a calculation method of the matching degree, or the like, may have other forms different from those shown in FIG. 8, which are not limited herein.

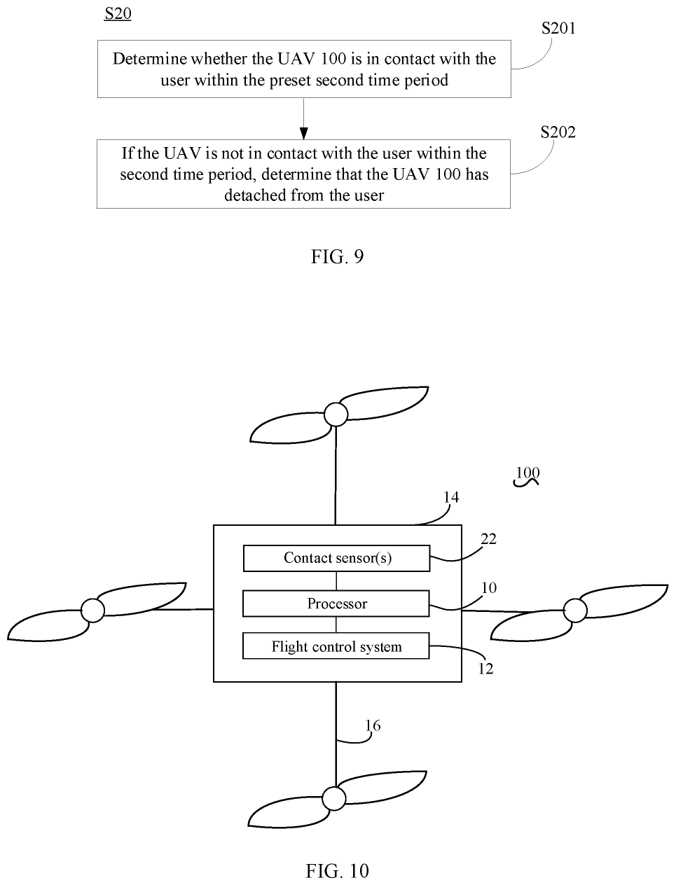

FIG. 9 is a schematic flow chart of another control method consistent with the disclosure. FIG. 10 is a schematic diagram of the functional circuits of another example of the UAV 100 consistent with the disclosure. In some embodiments, as shown in FIG. 10, the UAV 100 further includes one or more contact sensors 22 coupled to the processor 10 and configured to detect whether the UAV 100 is in contact with the user within a preset second time period.

As shown in FIG. 9, the process at S20 can include the following processes. At S201, whether the UAV 100 is in contact with the user within the preset second time period is determined.

At S202, if the UAV 100 is not in contact with the user within the second time period, it is determined that the UAV 100 has detached from the user.

In some embodiments, the processor 10 can be configured to determine whether the UAV 100 is in contact with the user within the preset second time period, and if the UAV 100 is not in contact with the user within the second time period, determine that the UAV 100 has detached from the user. That is, the processor 10 can be configured to perform the processes at S201 and S202.

In some embodiments, the one or more contact sensors 22 may include one or more of an infrared sensor, a pressure sensor, and a touch sensor. The one or more contact sensors 22 may include a plurality of contact sensors 22 arranged at a plurality of locations of the body 14 and/or the plurality of arms 16, and the types of the plurality of contact sensors 22 may be the same or different. After the UAV 100 being thrown off is determined at S10, the user being in contact with the UAV 100 within the preset second time period may indicate that the user has performed the throwing action to prepare to throw the UAV 100, but the user does not have really thrown the UAV 100. The user being not in contact with the UAV 100 within the preset second time period can indicate that the user has actually thrown the UAV 100. In some embodiments, the second time period can be preset when the UAV 100 is manufactured in the factory. In some embodiments, the second time period can be modified by the user. The second time period can be, for example, 2 seconds, 3 seconds, 5 seconds, or the like.

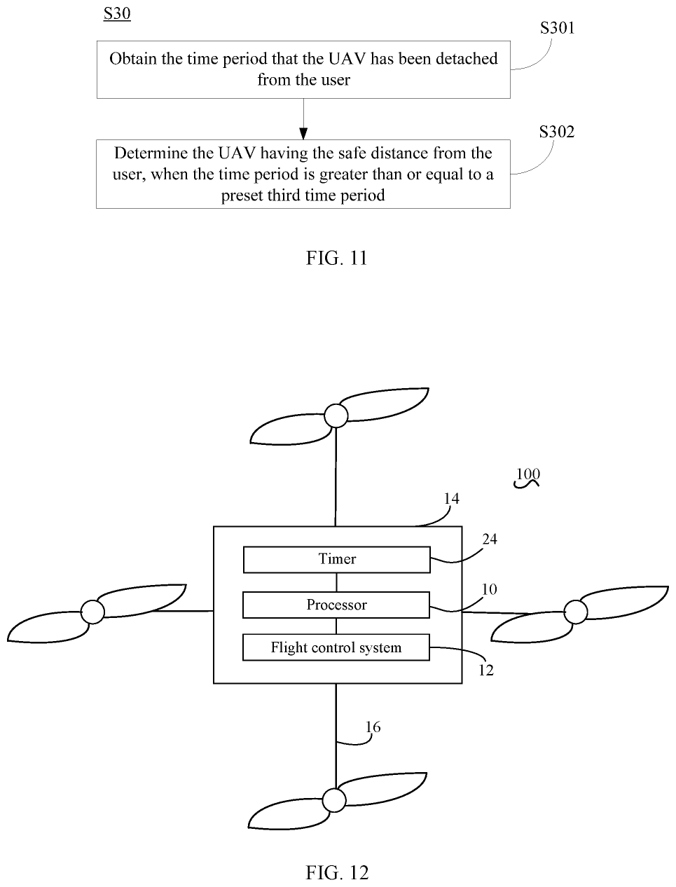

FIG. 11 is a schematic flow chart of another example control method consistent with the disclosure. FIG. 12 is a schematic diagram of the functional circuits of another example of the UAV 100 consistent with the disclosure. In some embodiments, as shown in FIG. 12, the UAV 100 further includes a timer 24 coupled to the processor 10 and configured to calculate a time period that the UAV 100 has been detached from the user.

As shown in FIG. 11, the process at S30 can include the following processes. At S301, the time period that the UAV 100 has been detached from the user is obtained. Such time period is also referred to as a “detach time period.”

At 302, when the time period is greater than or equal to a preset third time period, it is determined that the UAV 100 has a safe distance from the user.

In some embodiments, the processor 10 can be configured to obtain the time period that the UAV 100 has been detached from the user, and when the time period is greater than or equal to the preset third time period, determine that the UAV 100 has the safe distance from the user. That is, the processor 10 can be further configured to perform the processes at S301 and S302.

The suitable third time period can be preset, such that when the UAV 100 is thrown off from the user, the UAV 100 can have the safe distance from the user after detaching from the user for the third time period. In some embodiments, the UAV 100 can also have a sufficient distance from the ground, such that the UAV 100 does not touch the ground after being thrown off. The third time period can start from a time when the UAV 100 is detected having been detached from the user at S20. In some embodiments, the third time period can be preset when the UAV 100 is manufactured in the factory. In some embodiments, the third time period can be preset by the user according to different throwing environments, for example, a height of the throw, an angle of the throw, a strength of a current wind, a direction of the wind, and/or the like. The third time period can be, for example, 1 second, 1.2 seconds, 2.5 seconds, or the like.

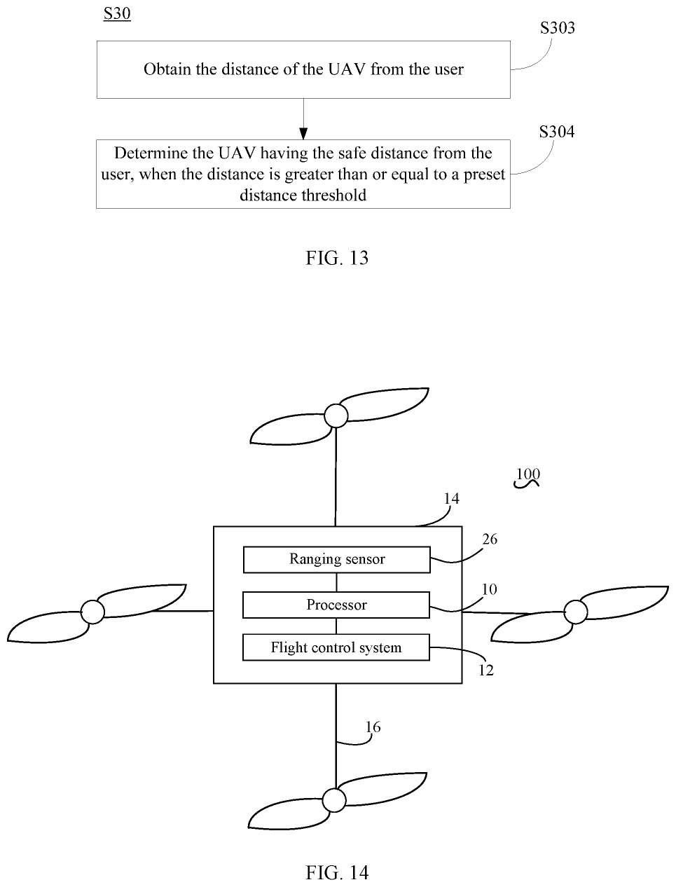

FIG. 13 is a schematic flow chart of another example control method consistent with the disclosure. FIG. 14 is a schematic diagram of the functional circuits of another example of the UAV 100 consistent with the disclosure. In some embodiments, as shown in FIG. 14, the UAV 100 further includes a ranging sensor 26 coupled to the processor 10 and configured to detect a distance of the UAV 100 from the user.

As shown in FIG. 13, the process at S30 can include the following processes. At 303, the distance of the UAV 100 from the user is obtained.

At 304, when the distance is greater than or equal to a preset distance threshold, it is determined that the UAV 100 has a safe distance from the user.

In some embodiments, the processor 10 can be configured to obtain the distance of the UAV 100 from the user, and determine that the UAV 100 has the safe distance from the user when the distance is greater than or equal to the preset distance threshold. That is, the processor 10 can be configured to perform the process at S303 and S304.

In some embodiments, the ranging sensor 26 may be one or more of an ultrasonic range finder, a radio range finder, and a laser range finder. The ranging sensor 26 can be mounted at any position of the body 14 or the plurality of arms 16 of the UAV 100.

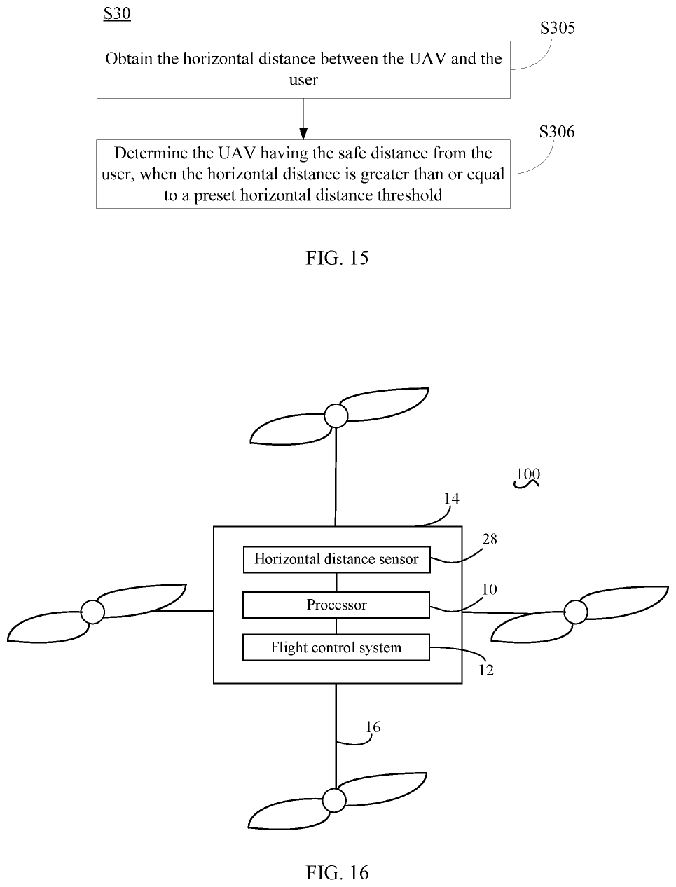

FIG. 15 is a schematic flow chart of another example control method consistent with the disclosure. FIG. 16 is a schematic diagram of the functional circuits of another example of the UAV 100 consistent with the disclosure. In some embodiments, as shown in FIG. 16, the UAV 100 further includes a horizontal distance sensor 28 coupled to the processor 10 and configured to detect a horizontal distance between the UAV 100 and the user.

As shown in FIG. 15, the process at S30 can include the following processes. At S305, the horizontal distance between the UAV 100 and the user is obtained.

At S306, when the horizontal distance is greater than or equal to a preset horizontal distance threshold, it is determined that the UAV 100 has a safe distance from the user.

In some embodiments, the processor 10 can be configured to obtain the horizontal distance between the UAV 100 and the user, and determine that the UAV 100 has the safe distance from the user when the distance is greater than or equal to the preset horizontal distance threshold. That is, the processor 10 can be further configured to perform the processes at S305 and S306.

When the horizontal distance between the user and the UAV 100 reaches the horizontal distance threshold, the UAV 100 can be considered to have the safe distance from the user. For example, when the user throws the UAV 100 horizontally, or the user throws the UAV 100 in a direction having a small angle to a horizontal plane, an increase of the vertical distance between the user and the UAV 100 can be much less than an increase of the horizontal distance in a relatively short time period. In this way, the horizontal distance between the user and the UAV 100 can be detected to determine whether the UAV 100 has the safe distance from the user, which can effectively ensure a safe throwing and reduce an amount of calculation of the processor 10. In some embodiments, the horizontal distance threshold can be preset when the UAV 100 is manufactured in the factory, for example, 3 meters, 4.5 meters, or the like.

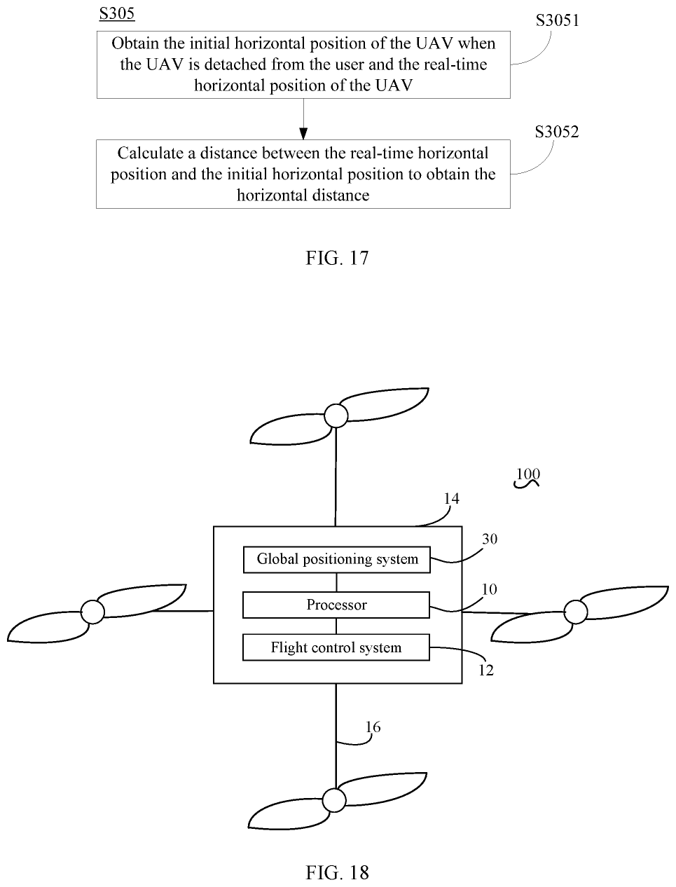

FIG. 17 is a schematic flow chart of another example control method consistent with the disclosure. FIG. 18 is a schematic diagram of the functional circuits of another example of the UAV 100 consistent with the disclosure. In some embodiments, as show in FIG. 18, the UAV 100 further includes a global positioning system 30 coupled to the processor 10 and configured to detect an initial horizontal position of the UAV 100 when the UAV 100 is detached from the user and a real-time horizontal position of the UAV 100.

As shown in FIG. 17, the process at S305 can include the following processes. At S3051, the initial horizontal position of the UAV 100 when the UAV 100 is detached from the user and the real-time horizontal position of the UAV 100 are obtained.

At 3052, a distance between the real-time horizontal position and the initial horizontal position is calculated to obtain the horizontal distance.

In some embodiments, the processor 10 can be configured to obtain the initial horizontal position of the UAV 100, when the UAV 100 is detached from the user, and the real-time horizontal position of the UAV 100, and calculate the distance between the real-time horizontal position and the initial horizontal position to obtain the horizontal distance. That is, the processor can be configured to perform the processes at S3051 and S3052.

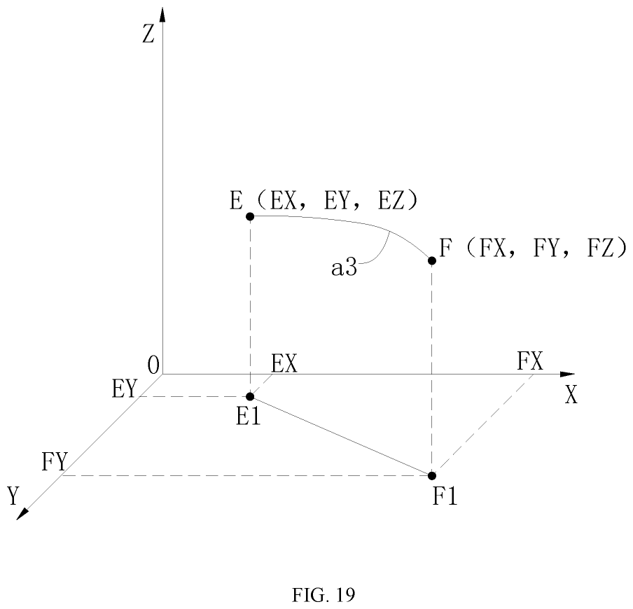

FIG. 19 schematically shows an example of calculating the horizontal distance consistent with the disclosure. For example, as shown in FIG. 19, when the processor 10 determines that the UAV 100 is detached from the user, a position of the UAV 100 in a space coordinate system (X, Y, Z) is at point E (EX, EY, EZ). The processor 10 can obtain the initial horizontal position point E1 (EX, EY) detected by the global positioning system 30, when the UAV 100 is detached from the user. Point E1 can be a projection of the point E on an XY plane. A trajectory after the UAV 100 is thrown off is shown as a3 in FIG. 19. When the UAV 100 is thrown to point F (FX, FY, FZ) (e.g., the point F may be any point on the trajectory a3), the processor 10 can obtain the real-time horizontal position point F1 (FX, FY) of the UAV 100. Point F1 can be the projection of point F on the XY plane. The processor 10 can calculate the distance between the real-time horizontal position F1 of the UAV 100 and the initial horizontal position E1 of the UAV 100 according to relevant mathematical theorem. For example, the horizontal distance can be calculated as |E1F1|=\sqrt{(EX−FX)²+(EY−FY)²}.

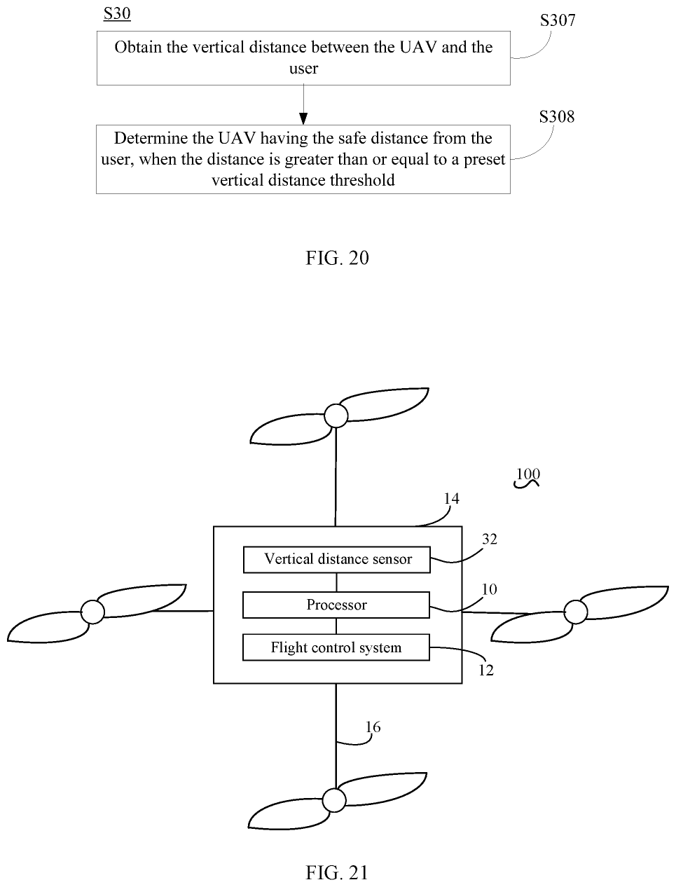

FIG. 20 is a schematic flow chart of another example control method consistent with the disclosure. FIG. 21 is a schematic diagram of the functional circuits of another example of the UAV 100 consistent with the disclosure. In some embodiments, as show in FIG. 21, the UAV 100 further includes a vertical distance sensor 32 configured to detect a vertical distance between the UAV 100 and the user.

As shown in FIG. 20, the process at S30 can include the following processes. At S307, the vertical distance between the UAV 100 and the user is obtained.

At S308, when the distance is greater than or equal to a preset vertical distance threshold, it is determined that the UAV 100 has the safe distance from the user.

In some embodiments, the processor 10 can be configured to obtain the vertical distance between the UAV 100 and the user, and determine that the UAV 100 has the safe distance from the user when the distance is greater than or equal to the preset vertical distance threshold. That is, the processor 10 can be further configured to perform the processes at S307 and S308.

When the vertical distance between the user and the UAV 100 reaches the vertical distance threshold, the UAV 100 can be considered to have the safe distance from the user. For example, when the user throws the UAV 100 vertically, or the user throws the UAV 100 in a direction having a small angle to a vertical plane, the increase of the vertical distance between the user and the UAV 100 can be much greater than the increase of the horizontal distance in the relatively short time period. In this way, the vertical distance between the user and the UAV 100 can be detected to determine whether the UAV 100 has the safe distance from the user, which can effectively ensure the safe throwing and reduce the amount of calculation of the processor 10. In some embodiments, the vertical distance threshold can be preset when the UAV 100 is manufactured in the factory.

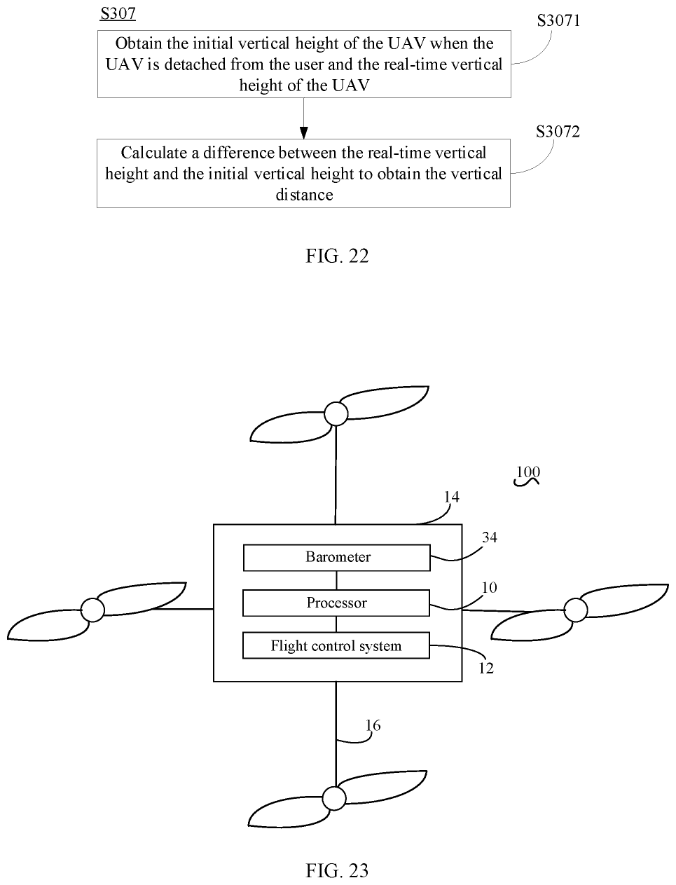

FIG. 22 is a schematic flow chart of another example control method consistent with the disclosure. FIG. 23 is a schematic diagram of the functional circuits of another example of the UAV 100 consistent with the disclosure. In some embodiments, as show in FIG. 23, the UAV 100 further includes a barometer 34 coupled to the processor 10 and configured to detect an initial vertical height of the UAV 100 when the UAV 100 is detached from the user and a real-time vertical position of the UAV 100.

As shown in FIG. 22, the process at S307 can include the following processes. At S3071, the initial vertical height of the UAV 100 when the UAV 100 is detached from the user and the real-time vertical height of the UAV 100 are obtained. At 3072, a difference between the real-time vertical height and the initial vertical height is calculated to obtain the vertical distance.

In some embodiments, the processor 10 can be configured to obtain the initial vertical height of the UAV 100 when the UAV 100 is detached from the user and the real-time vertical height of the UAV 100, and calculate the difference between the real-time vertical height and the initial vertical height to obtain the vertical distance. That is, the processor can be configured to perform the processes at S3071 and S3072.

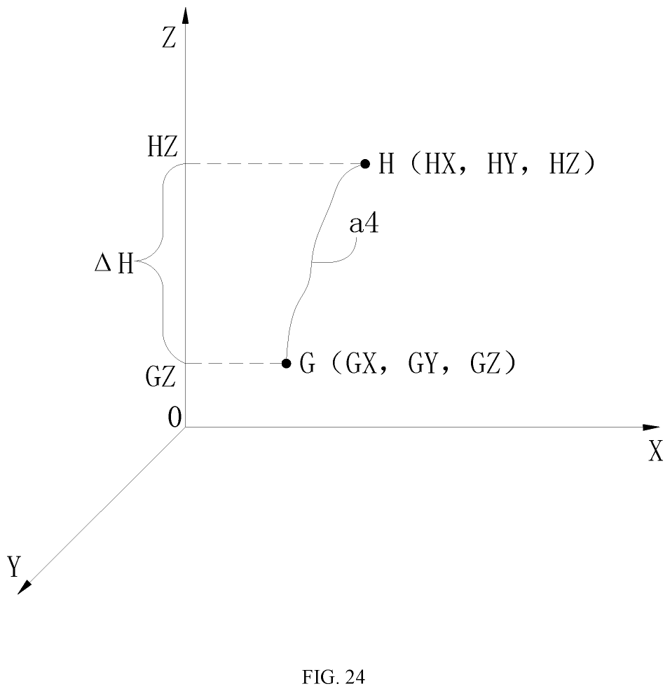

FIG. 24 schematically shows an example of calculating the vertical distance consistent with the disclosure. For example, as shown in FIG. 24, when the processor 10 determines that the UAV 100 is detached from the user, the position of the UAV 100 in the space coordinate system (X, Y, Z) is at point G (GX, GY, GZ). The processor 10 can obtain the initial vertical height GZ detected by the barometer 34 when the UAV 100 is detached from the user. GZ can be a height of a projection of point G on a Z axis. A trajectory after the UAV 100 is thrown off is shown as a4 in FIG. 24. When the UAV 100 is thrown to point H (HX, HY, HZ) (e.g., point H may be any point on the trajectory a4), the processor 10 can obtain the real-time vertical height HZ of the UAV 100. HZ is the height of the projection of the point H on the Z axis, and the processor 10 can calculate the vertical distance as ΔH=|GZ−HZ|.

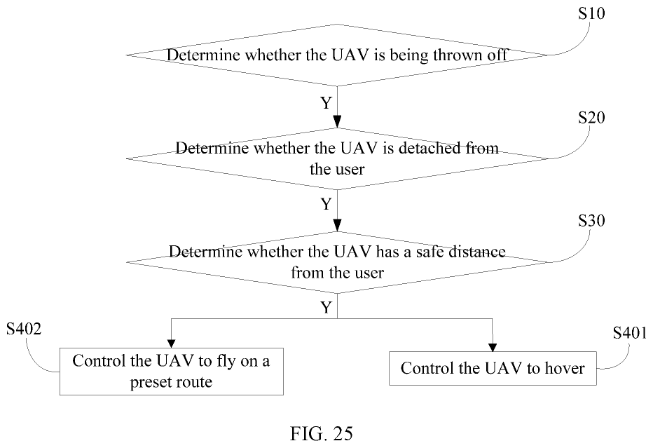

FIG. 25 is a schematic flow chart of another example control method consistent with the disclosure. In some embodiments, as shown in FIG. 25, the process at S40 can include process at S401 or S402. At S401, when the UAV 100 has the safe distance from the user, the UAV 100 is controlled to hover. At S402, when the UAV 100 has the safe distance from the user, the UAV 100 is controlled to fly on a preset route.

Referring again to FIG. 3, in some embodiments, the flight control system 12 can be configured to control the UAV 100 to hover or fly on the preset route, when the UAV 100 has the safe distance from the user.

Controlling the UAV 100 to hover when the safe distance is maintained from the user at S401 can be, for example, suitable for a user who needs to use a photographing system mounted at the UAV 100 to perform a selfie. In some embodiments, after the UAV 100 hovers, the user can control the UAV 100 to fly on another route by using a remote controller or the like. Controlling the UAV 100 to fly on the preset route when the safe distance is maintained from the user at S402 can simplify the take-off operation of the UAV 100. For example, the flight control system 12 can control a rotation of the motor of the UAV 100 to control the UAV 100 to fly.

As used herein, the terms “an embodiment,” “some embodiments,” “an example embodiment,” “an example,” “certain example,” “some examples,” or the like, refer to that the specific features, structures, materials, or characteristics described in connection with the embodiments or examples are included in at least one embodiment or example of the disclosure. The illustrative representations of the above terms are not necessarily referring to the same embodiments or examples. Furthermore, the specific features, structures, materials, or characteristics described may be combined in a suitable manner in any one or more embodiments or examples. Those skilled in the art can combine the different embodiments or examples described in the specification and the features of the different embodiments or examples without conflicting each other.

The terms “first,” “second,” or the like in the specification, claims, and the drawings of the disclosure are merely illustrative, e.g. distinguishing similar elements, defining technical features, or the like, and are not intended to indicate or imply the importance of the corresponding elements or the number of the technical features. Thus, features defined as “first” and “second” may explicitly or implicitly include one or more of the features. As used herein, “multiple” means two or more, unless there are other clear and specific limitations.

The logics and/or processes described in the flowcharts or in other manners may be, for example, an order list of the executable instructions for implementing logical functions, which may be implemented in any computer-readable storage medium and used by an instruction execution system, apparatus, or device, such as a computer-based system, a system including a processor, or another system that can fetch and execute instructions from an instruction execution system, apparatus, or device, or used in a combination of the instruction execution system, apparatus, or device. The computer-readable storage medium may be any apparatus that can contain, store, communicate, propagate, or transmit the program for using by or in a combination of the instruction execution system, apparatus, or device. The computer readable medium may include, for example, an electrical assembly having one or more wires, e.g., electronic apparatus, a portable computer disk cartridge. e.g., magnetic disk, a random access memory (RAM), a read only memory (ROM), an erasable programmable read only memory (EPROM or flash memory), an optical fiber device, or a compact disc read only memory (CDROM). In addition, the computer readable medium may be a paper or another suitable medium upon which the program can be printed. The program may be obtained electronically, for example, by optically scanning the paper or another medium, and editing, interpreting, or others processes, and then stored in a computer memory.

Those of ordinary skill in the art will appreciate that the example elements and steps described above can be implemented in electronic hardware, computer software, firmware, or a combination thereof. Multiple processes or methods may be implemented in a software or firmware stored in the memory and executed by a suitable instruction execution system. When being implemented in an electronic hardware, the example elements and processes described above may be implemented using any one or a combination of: discrete logic circuits having logic gate circuits for implementing logic functions on data signals, specific integrated circuits having suitable combinational logic gate circuits, programmable gate arrays (PGA), field programmable gate arrays (FPGAs), or the like.

Those of ordinary skill in the art will appreciate that the entire or part of a method described above may be implemented by relevant hardware instructed by a program. The program may be stored in a computer-readable storage medium. When being executed, the program includes one of the processes of the method or a combination thereof.

In addition, the functional units in the various embodiments of the present disclosure may be integrated in one processing unit, or each unit may be an individual physically unit, or two or more units may be integrated in one unit. The integrated unit described above may be implemented in electronic hardware or computer software. The integrated unit may be stored in a computer readable medium, which can be sold or used as a standalone product. The storage medium described above may be a read only memory, a magnetic disk, an optical disk, or the like.

It is intended that the embodiments disclosed herein be considered as example only and not to limit the scope of the disclosure. Changes, modifications, alterations, and variations of the above-described embodiments may be made by those skilled in the art within the scope of the disclosure.

What is claimed is:

1. A control method comprising:
determining whether an unmanned aerial vehicle (UAV) is being thrown off;
determining whether the UAV is detached from a user, in response to the UAV being thrown off;
determining whether the UAV has a safe distance from the user, in response to the UAV being detached from the user; and
controlling the UAV to fly in response to the UAV having the safe distance from the user.

2. The method of claim 1, further comprising:
determining whether the user is in contact with the UAV, before determining whether the UAV is being thrown off.

3. The method of claim 1, wherein determining whether the UAV is being thrown off comprises:
acquiring accelerations of the UAV within a preset time period to obtain an actual acceleration curve;
calculating a matching degree between the actual acceleration curve and an acceleration curve model corresponding to the UAV being thrown off; and
determining that the UAV is being thrown off, in response to the matching degree being greater than or equal to a preset matching degree threshold.

4. The method of claim 1, wherein determining whether the UAV is detached from the user comprises:
determining whether the UAV is in contact with the user within a preset time period; and
determining that the UAV is detached from the user, in response to the UAV being not in contact with the user within the preset time period.

5. The method of claim 1, wherein determining whether the UAV has the safe distance from the user comprises:
obtaining a detach time period that the UAV has been detached from the user; and
determining that the UAV has the safe distance from the user, in response to the detach time period being greater than or equal to a preset time period.

6. The method of claim 1, wherein determining whether the UAV has the safe distance from the user comprises:
obtaining a distance of the UAV from the user; and
determining that the UAV has the safe distance from the user, in response to the distance being greater than or equal to a preset distance threshold.

7. The method of claim 1, wherein determining whether the UAV has the safe distance from the user comprises:
obtaining a horizontal distance of the UAV from the user; and
determining that the UAV has the safe distance from the user, in response to the horizontal distance being greater than or equal to a preset horizontal distance threshold.

8. The method of claim 7, wherein obtaining the horizontal distance of the UAV from the user comprises:
obtaining an initial horizontal position of the UAV in response to the UAV being detached from the user and a real-time horizontal position of the UAV; and
calculating a distance between the real-time horizontal position and the initial horizontal position to obtain the horizontal distance.

9. The method of claim 1, wherein determining whether the UAV has the safe distance from the user comprises:
obtaining a vertical distance of the UAV from the user; and
determining that the UAV has the safe distance from the user, in response to the vertical distance being greater than or equal to a preset vertical distance threshold.

10. The method of claim 9, wherein obtaining the vertical distance of the UAV from the user comprises:
obtaining an initial vertical height of the UAV in response to the UAV being detached from the user and a real-time vertical height of the UAV; and
calculating a difference between the real-time vertical height and the initial vertical height to obtain the vertical distance.

11. The method of claim 1, wherein controlling the UAV to fly comprises:
controlling the UAV to hover in response to the UAV having the safe distance from the user; or
controlling the UAV to fly on a preset route in response to the UAV having the safe distance from the user.

12. An unmanned aerial vehicle (UAV) comprising:
a processor configured to:
determine whether the UAV is being thrown off;
determine whether the UAV is detached from a user, in response to the UAV being thrown off; and
determine whether the UAV has a safe distance from the user, in response to the UAV being detached from the user; and
a flight control system coupled to the processor and configured to:
control the UAV to fly in response to the UAV having the safe distance from the user.

13. The UAV of claim 12, wherein the processor is further configured to:
determine whether the user is in contact with the UAV, before determining whether the UAV is being thrown off.

14. The UAV of claim 12, further comprising:
a memory coupled to the processor and configured to store an acceleration curve model corresponding to the UAV being thrown off; and
an accelerator configured to detect and record accelerations of the UAV within a preset time period;
wherein the processor is further configured to:
acquire the accelerations of the UAV within the preset time period to obtain an actual acceleration curve;
calculate a matching degree between the actual acceleration curve and the acceleration curve model; and
determine that the UAV is being thrown off, in response to the matching degree being greater than or equal to a preset matching degree threshold.

15. The UAV of claim 12, further comprising;
one or more contact sensors coupled to the processor and configured to detect whether the UAV is in contact with the user within a preset time period;
wherein the processor is further configured to:
determine whether the UAV is in contact with the user within the preset time period; and
determine that the UAV is detached from the user, in response to the UAV being not in contact with the user within the preset time period.

16. The UAV of claim 15, wherein the one or more contact sensors comprise one or more of an infrared sensor, a pressure sensor, and a touch sensor.

17. The UAV of claim 12, further comprising:
a timer coupled to the processor and configured to calculate a detach time period that the UAV has been detached from the user;
wherein the processor is further configured to:
obtain the detach time period; and
determine that the UAV has the safe distance from the user, in response to the detach time period being greater than or equal to a preset time period.

18. The UAV of claim 12, further comprising:
a ranging sensor coupled to the processor and configured to detect a distance of the UAV from the user;
wherein the processor is further configured to:
obtain the distance; and
determine that the UAV has the safe distance from the user, in response to the distance being greater than or equal to a preset distance threshold.

19. The UAV of claim 12, further comprising:
a horizontal distance sensor coupled to the processor and configured to detect a horizontal distance of the UAV from the user;
wherein the processor is further configured to:
obtain the horizontal distance; and
determine that the UAV has the safe distance from the user, in response to the horizontal distance being greater than or equal to a preset horizontal distance threshold.

20. The UAV of claim 19, further comprising:
a global positioning system coupled to the processor and configured to detect an initial horizontal position of the UAV in response to the UAV being detached from the user and a real-time horizontal position of the UAV;
wherein the processor is further configured to:
obtain the initial horizontal position and the real-time horizontal position; and
calculate a distance between the real-time horizontal position and the initial horizontal position to obtain the horizontal distance.

21. The UAV of claim 12, further comprising:
a vertical distance sensor coupled to the processor and configured to detect a vertical distance of the UAV from the user;
wherein the processor is further configured to:
obtain the vertical distance; and
determine that the UAV has the safe distance from the user, in response to the vertical distance being greater than or equal to a preset vertical distance threshold.

22. The UAV of claim 21, further comprising:
a barometer coupled to the processor and configured to detect an initial vertical height of the UAV in response to the UAV being detached from the user and a real-time vertical height of the UAV;
wherein the processor is further configured to:
obtain the initial vertical height o and the real-time vertical height; and
calculate a difference between the real-time vertical height and the initial vertical height to obtain the vertical distance.

23. The UAV of claim 12, wherein the flight control system is further configured to:
control the UAV to hover in response to the UAV having the safe distance from the user; or
control the UAV to fly on a preset route in response to the UAV having the safe distance from the user.
